(19) United States
(12) Patent Application Publication
(10) Pub. No.: US 2008/0179161 A1
(43) Pub. Date: Jul. 31, 2008

(54) Friction Plate for Wet-Type Multiplate Clutch

(75) Inventors: Masahiro Kobayashi, Fukuroi-shi (JP); Tsuyoshi Hirayanagi, Fukuroi-shi (JP)

Correspondence Address: CERMAK KENEALY & VAIDYA, LLP, 515 EAST BRADDOCK RD SUITE B, Alexandria, VA, 22314, US

(73) Assignee: NSK-Warner K.K., Tokyo (JP)

(21) Appl. No.: 11/964,169

(22) Filed: Dec. 26, 2007

(30) Foreign Application Priority Data
Jan. 25, 2007 (JP) 2007-015153

(51) Int. Cl. F16D 13/74

(52) U.S. Cl. 192/107 R

(57) ABSTRACT

A friction plate for a wet-type multiplate clutch is provided with plural segment pieces of a friction lining, which are bonded at angular intervals on the friction plate. Each of the segment pieces has at least one first oil groove and at least one second oil groove. The first oil groove opens to a radially-inner side of its corresponding segment piece and has a closed end portion located in a radially-intermediate part of the corresponding segment piece. The second oil groove opens to a radially-outer side of the corresponding segment piece and has a closed end portion located in another radially-intermediate part of the corresponding segment piece. The first oil groove is provided with an oil pocket at its closed end portion.

### CROSS-REFERENCE TO RELATED APPLICATION

This application claims the priority of Japanese Patent Application 2007-015153 filed Jan. 25, 2007, which is incorporated herein by reference.

### FIELD OF THE INVENTION

This invention relates to a friction plate for a wet-type multiplate cutch useful as a clutch, a brake or the like in an automatic transmission.

### BACKGROUND OF THE INVENTION

FIG. 1 is a cross-sectional view illustrating the fundamental construction of a wet-type multiplate clutch 10. FIG. 1 shows a clutch casing 21, a counterpart hub 22, a spline groove 23 formed on the clutch casing 21, a spline groove 24 formed on the hub 22, a piston 25 for pressing separator plates 30 and friction plates 40 against a backing plate 26, a snap ring 27 supporting the backing plate 26, and a sealing ring 28 for the piston 25. The separator plates 30 are maintained in fitting engagement with the spline groove 23, while the friction plates 40 are maintained in fitting engagement with the spline groove 24.

In recent years, there is an ever-increasing demand for improvements in the fuel economy of automobiles. Keeping in step with this trend, there is an outstanding demand for a further reduction in idling drag between friction plates and separator plates during non-engagement of a clutch in an automatic transmission.

There have hence been employed friction plates provided with friction linings, each of which has one or more oil grooves having closed end portions to separate the friction plates from their associated separator plates during non-engagement of a clutch and also has one or more oil passages extending radially through the friction lining to feed lube oil onto a friction surface for the prevention of seizure during engagement of the clutch. (See, for example, JP-A-11-141570 and JP-A-2005-76759)

To improve the shift response in an attempt to make not only an improvement in fuel economy and but also improvements in engine performance, the clearances between friction plates and their associated separator plates have become still smaller recently than before, tending to result in a greater drag torque due to intervening oil films during idling.

### SUMMARY OF THE INVENTION

An object of the present invention is to provide a wet-type multiplate clutch, which has heat resistance, is substantially reduced in drag torque during idling, and produces no shock upon engagement.

Lube oil is fed from the radially-inner side of friction plates, and is then drawn onto friction surfaces. Once it enters between the friction plates and their associated separator plates, its drainage does not take place quickly. Especially when the clearances between the friction plates and the separator plates are small and the clutch is in a low rpm range, this tendency is pronounced so that a significant drag torque is produced due to the viscosity of the lube oil between the plates.

When the friction surface of each friction lining is provided with plural oil grooves opening to a radially-outer side of the friction lining (hereinafter called “second oil grooves”), lube oil which has been drawn onto the friction surface from an oil way is smoothly drained to the radially-outer side so that during idling, a drag torque can be reduced. This drag-torque reducing effect is high especially during low-speed rotation. Because the drawn lube oil is smoothly drained, frictional heat which is produced during clutch engagement is also removed smoothly together with the lube oil, so that the heat resistance of the friction lining is improved.

When the friction surface of each friction lining is provided with plural oil grooves opening to a radially-inner side of the friction lining and having closed radial outer end portions (hereinafter called “first oil grooves”), these oil grooves are effective in keeping uniform the clearances between the friction plates and their associated separator plates during idling owing to the action that separate the friction plates and the separator plates from each other and, when the clutch is disengaged, can smoothly separate the friction plates and the separator plates from each other. These oil grooves are, therefore, also effective in reducing a drag torque during idling.

When a friction lining is formed into segment pieces and these segment pieces are bonded at angular intervals on one side of a core plate, oil passages are formed between the respective segment pieces such that the oil passages extend through the friction lining from the radially-inner side to the radially-outer side. Accordingly, any extra lube oil is promptly drained, thereby effectively reducing a drag torque during idling.

In an initial stage of clutch engagement, however, the lube oil is quickly drained from the friction surface via these oil grooves and oil passages, and therefore, the cushioning effect of the lube oil is reduced to cause abrupt grabbing of the clutch in the initial stage of clutch engagement. The use of this clutch as a clutch, a brake or the like in an automatic transmission causes a problem that a shock is produced upon shifting.

To solve the above-described problem, the present invention provides a friction plate for a wet-type multiplate clutch, said friction plate being provided with plural segment pieces of a friction lining bonded thereon at angular intervals between the segment pieces, each of the segment pieces having at least one first oil groove and at least one second oil groove, said first oil groove opening to a radially-inner side of its corresponding segment piece and having a closed end portion located in a radially-intermediate part of the corresponding segment piece, and said second oil groove opening to a radially-outer side of the corresponding segment piece and having a closed end portion located in another radially-intermediate part of the corresponding segment piece, wherein: the first oil groove is provided with an oil pocket at the closed end portion thereof.

Owing to the above-described construction, the friction plate according to the present invention has made it possible to reduce a drag torque during idling of a clutch, and has also made it possible to avoid grabbing in an initial stage of clutch engagement because the lube oil in the oil pocket is drained onto the friction surface to produce cushioning effect.

The present invention has made it possible to fully meet the demand for improvements in the shift response in recent years. Even under such a lubrication environment that lots of lube oil are fed, the present invention can keep a drag torque small during idling and can avoid grabbing in an initial stage of clutch engagement.

### BRIEF DESCRIPTION OF THE DRAWINGS

FIG. 1 is a cross-sectional view illustrating the fundamental construction of a wet-type multiplate clutch.

FIG. 2 is a front view of a friction plate according to a first embodiment of the present invention.

FIG. 3 is an enlarged fragmentary front view of the friction plate of FIG. 2.

FIG. 4 is similar to FIG. 3, but illustrates a friction plate according to a second embodiment of the present invention.

FIG. 5 is a graph illustrating advantageous effects of the present invention.

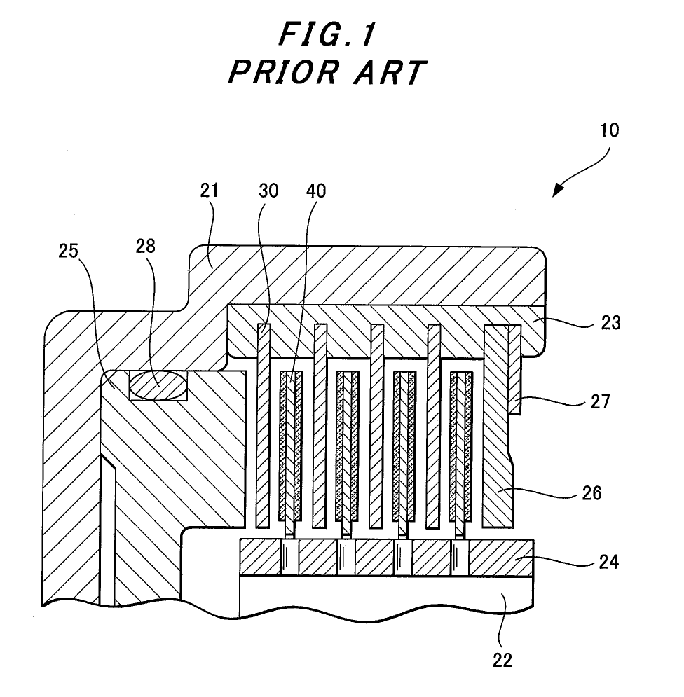

### DETAILED DESCRIPTION OF THE INVENTION AND PREFERRED EMBODIMENTS

Each oil groove opening to the radially-outer side of its corresponding segment piece (i.e., the second oil groove) has oil-draining effect. Its oil drainage increases when its angular width is made greater toward the radially-outer side.

Each oil groove opening to the radially-inner side of its corresponding segment piece (i.e., the first oil groove) is effective in reducing a drag torque during idling. Its effect to separate the associated friction plate and separator plate from each other becomes greater when its angular width is made narrower from its open end portion toward its corresponding oil pocket.

The shapes of the first and second oil grooves and each oil pocket can be appropriately determined depending upon the friction surface area, friction characteristics, lube-oil feed rate, and so on.

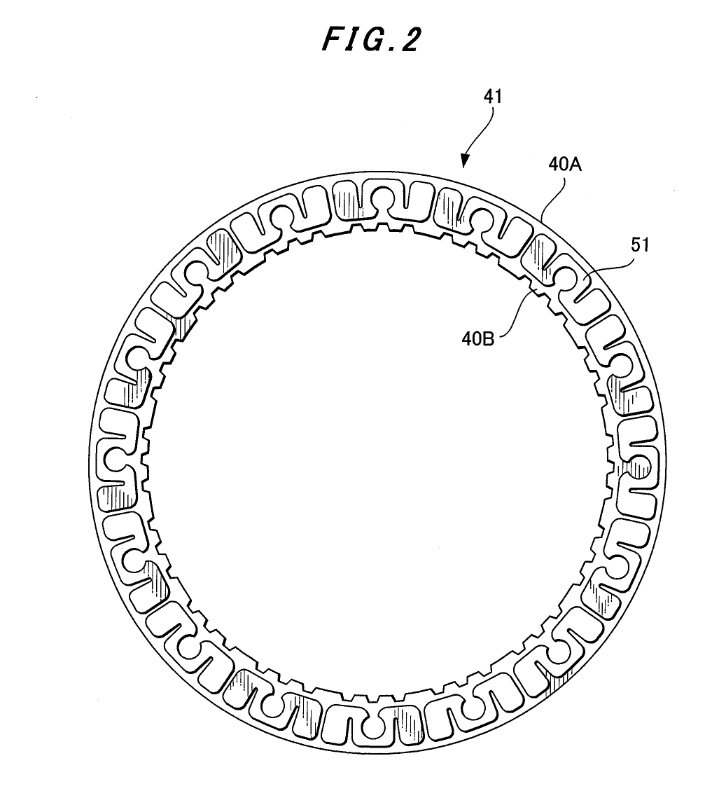

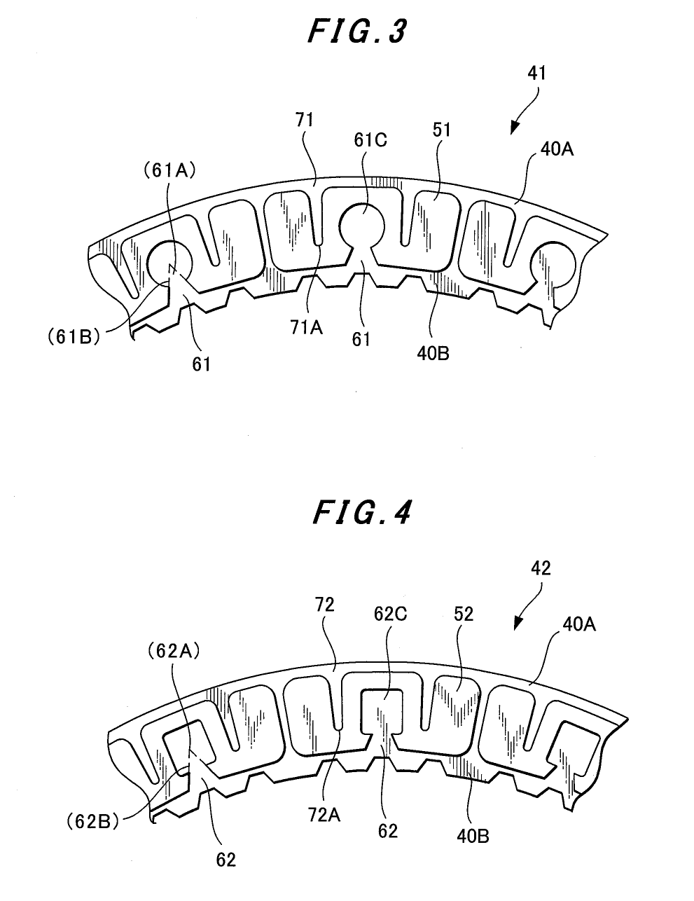

Certain preferred embodiments of the present invention will hereinafter be described with reference to the accompanying drawings. FIG. 2 is a front view of a friction plate 41 according to the first embodiment of the present invention. FIG. 3 is an enlarged fragmentary view of the friction plate 41 of FIG. 2, and shows a core plate 40A, segment pieces 51 of a friction lining, and spline teeth 40B to be maintained in fitting engagement with the spline groove 24 formed on the hub 22.

In each segment piece 51, a first oil groove 61 opening to the radially-inner side of the segment piece 51 would become such an imaginary oil groove as indicated by broken lines 61B in the figure and would have an imaginary closed end portion 61A, if it were not provided with such an oil pocket as required in the present invention. In this embodiment, the first oil groove 61 is not such an imaginary oil groove but has an oil pocket 61C formed at the imaginary end portion 61B. In the first embodiment shown in FIGS. 2 and 3, the oil pocket 61C is formed as a circle. Numeral 71 designates each second oil groove, a closed end of which is indicated at sign 71A.

A flow of lube oil can be improved further when the position of the imaginary closed end portion 61A of each first oil groove 61 and the position of the closed end portion 71A of each second oil groove 71 are set beyond the radial center line of their corresponding segment piece, respectively.

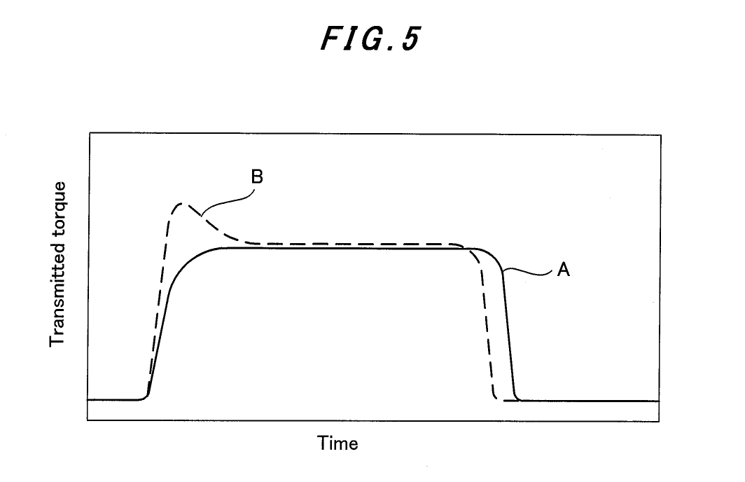

FIG. 4 illustrates a friction plate 42 according to the second embodiment of the present invention. The shapes and the like of each first oil groove 62 and each second oil groove 72 are the same as in FIG. 3. In this second embodiment, however, each oil pocket 62C is formed as a rectangle. The shape of each oil pocket 62C can be appropriately determined depending on the use conditions as described above. It is to be noted that signs 52, 62A, 62B and 72A of FIG. 4 correspond to signs 51, 61A, 61B and 71A of FIG. 3, respectively.

FIG. 5 diagrammatically illustrates advantageous effects of the present invention, in which transmitted torque is plotted along the ordinate while time is plotted along the abscissa.

A broken line B shows time-torque characteristics of a conventional clutch, and indicates that grabbing takes place in an initial stage of clutch engagement. A solid line A corresponds to the present invention, and indicates that a torque is transmitted uniformly.

1. A friction plate for a wet-type multiplate clutch, said friction plate being provided with plural segment pieces of a friction lining bonded thereon at angular intervals between said segment pieces, each of said segment pieces having at least one first oil groove and at least one second oil groove, said first oil groove opening to a radially-inner side of its corresponding segment piece and having a closed end portion located in a radially-intermediate part of the corresponding segment piece, and said second oil groove opening to a radially-outer side of the corresponding segment piece and having a closed end portion located in another radially-intermediate part of the corresponding segment piece, wherein:
said first oil groove is provided with an oil pocket at said closed end portion thereof.

2. A friction plate according to claim 1, wherein said at least one first oil groove becomes narrower from an open end portion thereof toward said oil pocket.

3. A friction plate according to claim 1, wherein said at least one second oil groove becomes narrower from an open end portion thereof toward said closed end portion thereof.

4. A friction plate according to claim 1, wherein said oil pocket is circular.

5. A friction plate according to claim 1, wherein said oil pocket is rectangular.

6. A friction plate according to claim 1, wherein said closed end portions of said at least one first oil groove and at least one second oil groove are located beyond a radial center line of their corresponding segment piece, respectively.
